(19) United States
(12) Patent Application Publication
(10) Pub. No.: US 2025/0097807 A1
(43) Pub. Date: Mar. 20, 2025

(54) COMMUNICATION CONTROL DEVICE, COMMUNICATION CONTROL METHOD, AND RECORDING MEDIUM

(71) Applicant: NEC Corporation, Minato-ku, Tokyo (JP)

(72) Inventors: Masayuki TAKEKAWA, Tokyo (JP); Kosei KOBAYASHI, Tokyo (JP); Masaaki TAKEUCHI, Tokyo (JP); Kazuki OGATA, Tokyo (JP); Nobuyuki TOZAWA, Tokyo (JP)

(73) Assignee: NEC Corporation, Minato-ku, Tokyo (JP)

(21) Appl. No.: 18/729,662

(22) PCT Filed: Feb. 22, 2022
(86) PCT No.: PCT/JP2022/007318

§ 371 Date: Jul. 17, 2024

(51) Int. Cl. H04W 36/30; G06T 7/70; G06V 20/58; H04W 4/44; H04W 36/14

(52) U.S. Cl. CPC H04W 36/30; G06T 7/70; G06V 20/58; H04W 4/44; H04W 36/14; G06T 2207/30261; G06V 2201/08

(57) ABSTRACT

A communication control device that is mounted in a moving body, the communication control device including: a detecting unit that detects, based on image data obtained by imaging a direction of a base station to which the moving body is connected, a blocking object between the moving body and the base station to which the moving body is connected; and a predicting unit that predicts, based on a position and a size of the detected blocking object, a change in communication quality of a first wireless network used by the moving body for external communication.

### TECHNICAL FIELD

The present invention relates to a communication control device, a communication control method, and a recording medium.

### BACKGROUND ART

PTL 1 discloses a mobile terminal and a communication quality prediction method capable of predicting fluctuations in communication quality. Specifically, it is described that the mobile terminal includes: a terminal information generation unit that generates terminal information including at least one or more pieces of information of a position, a posture, a motion, control information, camera information, sensor information, and past communication information of the mobile terminal; and a communication prediction unit that estimates the current or future communication quality from current terminal information by using a communication quality model generated by learning a relationship between the communication quality of the wireless communication and the terminal information.

### CITATION LIST

### Patent Literature

PTL 1: WO 2021/064848 A1

### SUMMARY OF INVENTION

### Technical Problem

The following analysis was given by the inventor. In the scheme of PTL 1, there is a problem that it is necessary to prepare teaching data using terminal information including at least one or more pieces of information of a position, a posture, a motion, control information, camera information, sensor information, and past communication information of the mobile terminal and generate a communication quality model. In addition, it is considered that the current or future communication quality cannot be appropriately estimated with one or more pieces of terminal information to be selected.

An object of the present invention is to provide a communication control device, a communication control method, and a program capable of satisfactorily predicting a change in communication quality of a currently used wireless network.

### Solution to Problem

According to a first viewpoint, a communication control device, is provided, that is mounted in a moving body, including a detecting means for detecting, based on image data obtained by imaging a direction of a base station to which the moving body is connected, a blocking object between the moving body and the base station to which the moving body is connected, and a predicting means for predicting, based on a position and a size of the detected blocking object, a change in communication quality of a first wireless network used by the moving body for external communication.

According to a second viewpoint, a communication control method is provided, including detecting, based on image data obtained by imaging a direction of a base station to which a moving body is connected, a blocking object between the moving body and the base station to which the moving body is connected, and predicting, based on a position and a size of the detected blocking object, a change in communication quality of a first wireless network used by the moving body for external communication.

According to a third viewpoint, a program, is provided, that causes a computer constituting a communication control device mounted on a moving body to execute a process of detecting, based on image data obtained by imaging a direction of a base station to which the moving body is connected, a blocking object between the moving body and the base station to which the moving body is connected, and a process of predicting, based on a position and a size of the detected blocking object, a change in communication quality of a first wireless network used by the moving body for external communication. This computer program can be recorded on a computer-readable (non-transitory) recording medium. That is, the present invention can also be embodied as a computer program product.

### Advantageous Effects of Invention

According to the present invention, a communication control device, a communication control method, and a recording medium, capable of satisfactorily predicting a change in communication quality of a currently used wireless network, are provided.

### BRIEF DESCRIPTION OF DRAWINGS

FIG. 1 is a diagram illustrating a configuration of one example embodiment of the present invention.

FIG. 2 is a diagram for explaining an operation of one example embodiment of the present invention.

FIG. 3 is a diagram for explaining an operation of one example embodiment of the present invention.

FIG. 4 is a diagram illustrating a configuration of a first example embodiment of the present invention.

FIG. 5 is a functional block diagram illustrating a detailed configuration of the in-vehicle terminal according to the first example embodiment of the present invention.

FIG. 6 is a flowchart illustrating an operation of the in-vehicle terminal according to the first example embodiment of the present invention.

FIG. 7 is a diagram for explaining a method of calculating a deterioration period of communication quality by the in-vehicle terminal according to the first example embodiment of the present invention.

FIG. 8A is a diagram for explaining an operation of the in-vehicle terminal according to the first example embodiment of the present invention.

FIG. 8B is a diagram for explaining the operation of the in-vehicle terminal according to the first example embodiment of the present invention.

FIG. 9 is a diagram for explaining another method of calculating a deterioration period of communication quality by the in-vehicle terminal according to the first example embodiment of the present invention.

FIG. 10 is a diagram illustrating a configuration of a second example embodiment of the present invention.

FIG. 11A is a functional block diagram illustrating a configuration of an in-vehicle terminal according to the second example embodiment of the present invention.

FIG. 11B is a functional block diagram illustrating the configuration of the in-vehicle terminal according to the second example embodiment of the present invention.

FIG. 12 is a diagram illustrating a configuration of a computer that can function as a driving assistance device of the present invention.

### EXAMPLE EMBODIMENT

First, an outline of an example embodiment of the present invention will be described with reference to the drawings. The reference numerals in the drawings attached to this outline are attached to each element for convenience as an example for assisting understanding, and are not intended to limit the present invention to the illustrated aspects. Connection lines between blocks in the drawings and the like referred to in the following description include both bidirectional and unidirectional connections. A unidirectional arrow schematically indicates a flow of a main signal (data), and does not exclude bidirectionality. Although there are ports and interfaces at connection points of input and output of each block in the drawing, illustration is omitted.

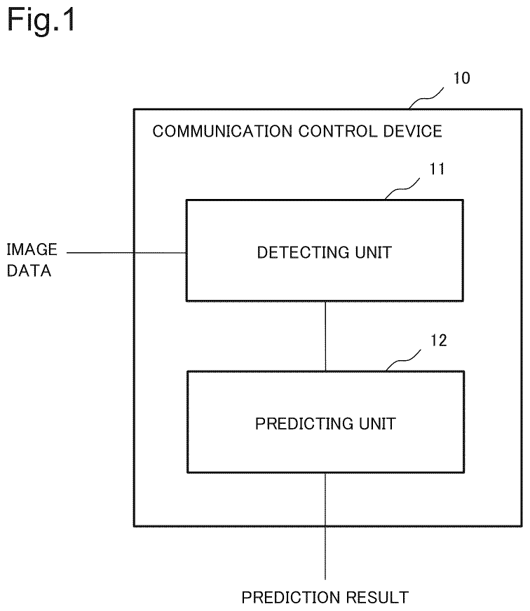

In one example embodiment of the present invention, as illustrated in FIG. 1, the present invention can be achieved by a communication control device 10 including a detecting means 11 and a predicting means 12 and mounted on a moving body. More specifically, the detecting means 11 detects a blocking object between the moving body and a base station to which the moving body is connected, based on image data obtained by imaging a direction of the base station to which the moving body is connected.

The predicting means 12 predicts a change in communication quality of a first wireless network used by the moving body for communication with the outside, based on the detected position and size of the blocking object. The change in communication quality predicted by the predicting means may be disconnection or instantaneous interruption of a radio link, or may be deterioration of a communication throughput, or deterioration of a delay time or a response time of communication.

The communication control device 10 operates as follows. First, based on image data obtained by imaging a direction of a base station 20 to which the moving body on which a host device is mounted is connected, the communication control device 10 detects a blocking object 30 that affects communication between the moving body and the base station 20 to which the moving body is connected.

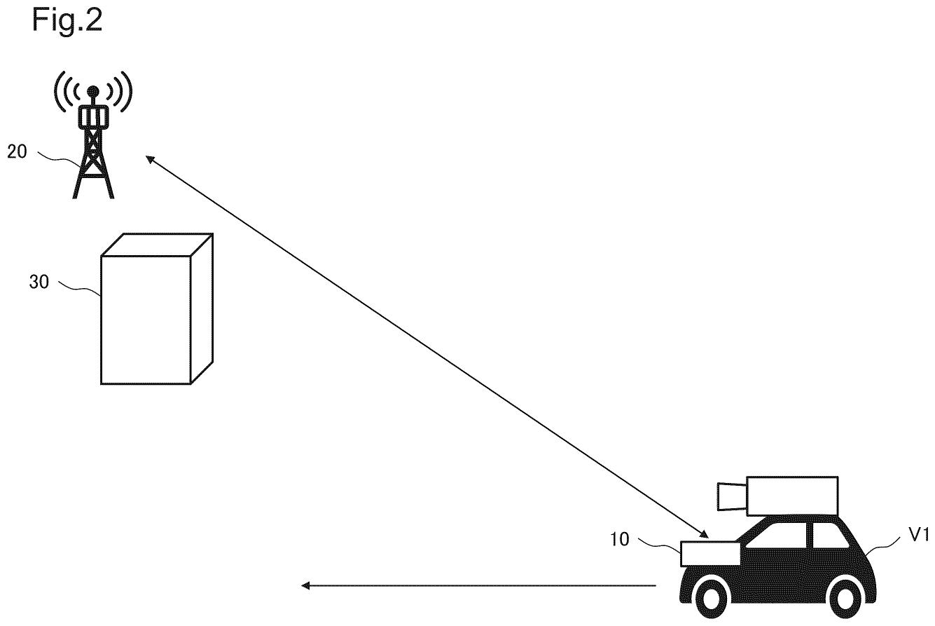

For example, as illustrated in FIG. 2, it is assumed that the moving body (vehicle V1) on which the communication control device 10 is mounted is moving in a right direction from the left side in FIG. 2. At this time, based on the image data obtained by imaging the direction of the base station 20, the communication control device 10 detects the blocking object 30 that may affect the communication between the moving body (vehicle V1) and the base station 20 to which the moving body (vehicle V1) is connected.

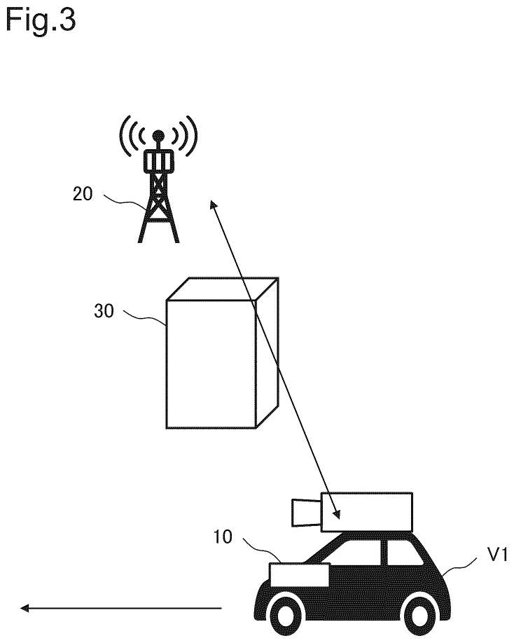

Then, the communication control device 10 predicts a change in communication quality of the first wireless network used by the moving body for communication with the outside, based on the detected position and size of the blocking object 30. For example, as illustrated in FIG. 3, in a case where the moving body (vehicle V1) moves in the right direction, the communication between the moving body (vehicle V1) and the base station 20 is deteriorated by the blocking object 30 due to the influence of the blocking object 30. The communication control device 10 may predict the change in the communication quality of the first wireless network by using the moving speed of the moving body (vehicle V1) in addition to the position and size of blocking object 30.

The predicted change in the communication quality of the first wireless network can be used for selection (switching) of another communication means in the moving body (vehicle V1), determination of necessity of changing the communication scheme with the base station 20, and the like. For example, the moving body (vehicle V1) can continue communication by connecting to a second wireless network different from the first wireless network.

The predicted change in the communication quality of the first wireless network can also be used to control an application program used in the moving body (vehicle V1). For example, the moving body (vehicle V1) changes the band allocated to the application program being used. Accordingly, an application program having a high priority can be less likely to be affected by deterioration in communication quality.

In addition, the following are conceivable as measures of the moving body (vehicle V1) or a control center that controls the moving body (vehicle V1) in response to the change in the communication quality of the first wireless network.

### <Application Level>

For example, by changing video quality, the moving body (vehicle V1) can cope with a change in communication quality that may occur in the future. In addition, by changing a driving mode, the moving body (vehicle V1) can cope with a change in communication quality that may occur in the future. For example, by shifting from a remote control mode requiring a large amount of information exchange to an autonomous driving mode in which autonomous driving is performed without using communication, it is possible to cope with the deterioration in communication quality. In addition, by stopping or decelerating, the moving body (vehicle V1) can cope with a change in communication quality that may occur in the future. For example, the moving body (vehicle V1) stops or decelerates before the connection with the control center is disconnected, so that the moving body (vehicle V1) can safely cope with the stop or the delay of the control. In addition, by prefetching and issuing a control command to the moving body (vehicle V1), the control center can cope with a change in communication quality that may occur in the future. For example, the control center predicts a delay in sensing information and a delay in command transmission due to a change in communication quality, and prefetches and issues a control command.

### <Network Level>

By switching the base station in the same network, the moving body (vehicle V1) can cope with a change in communication quality that may occur in the future.

### <Link Level>

By changing the frequency used for communication with the base station, the moving body (vehicle V1) can cope with a change in communication quality that may occur in the future. For example, the influence of the blocking object can be reduced by changing the frequency from the millimeter wave to the Sub6. In addition, by performing prefetch control of link adaptation, the moving body (vehicle V1) can cope with a change in communication quality that may occur in the future. Usually, control such as lowering an MCS level is performed after the deterioration in communication quality is found, but the deterioration in communication quality can be coped with by lowering the MCS level first. Even by performing prefetch control of beamforming, the moving body (vehicle V1) can cope with a change in communication quality that may occur in the future. For example, in a case where blocking is predicted when beam formation is performed in a direction directly toward the base station, the deterioration in communication quality can be coped with by performing beam formation in a reflected wave direction before the beam is lost.

### First Example Embodiment

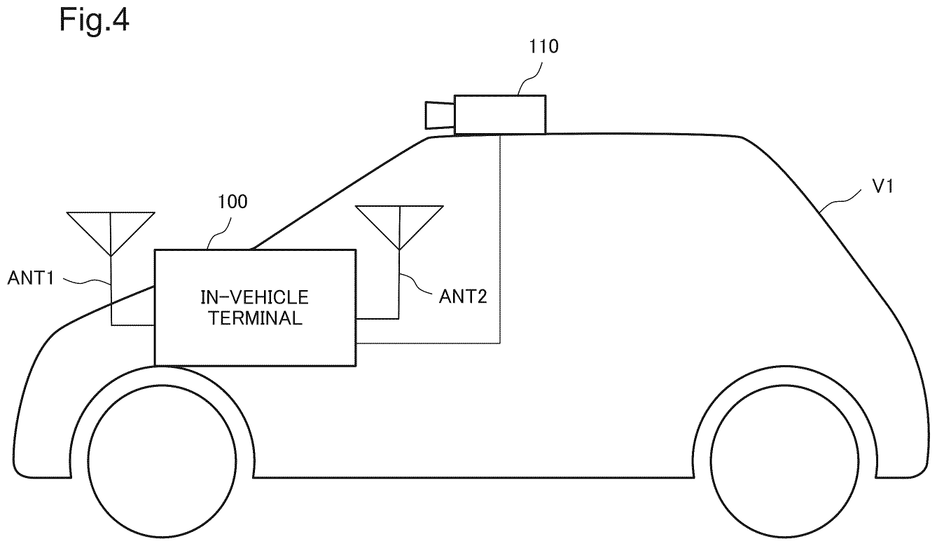

Next, a first example embodiment of the present invention will be described in detail with reference to the drawings. FIG. 4 is a diagram illustrating a configuration of the first example embodiment of the present invention. Referring to FIG. 4, the vehicle V1 on which a camera 110 and an in-vehicle terminal 100 functioning as a communication control device are mounted is illustrated.

As the camera 110, a drive recorder of the vehicle V1 or a surroundings monitoring camera of the vehicle can be used. In the example of FIG. 4, the camera 110 is directed forward, but it is preferable that a plurality of cameras is provided such that the entire circumference can be captured.

The in-vehicle terminal 100 includes a first antenna ANT1 for connecting to the first wireless network and a second antenna ANT2 for connecting to the second wireless network.

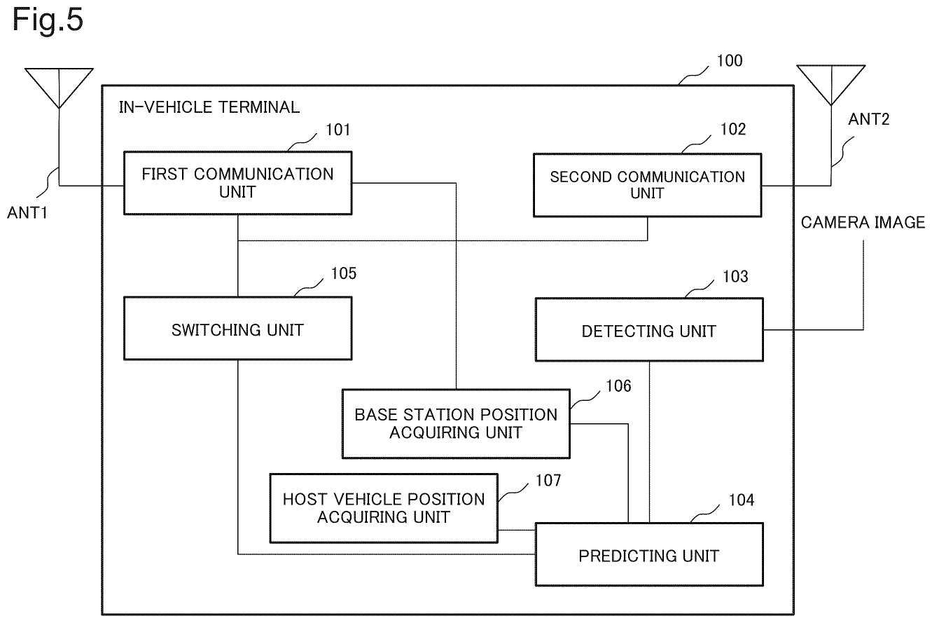

FIG. 5 is a functional block diagram illustrating a detailed configuration of the in-vehicle terminal 100. Referring to FIG. 5, a configuration including a first communication means 101, a second communication means 102, a detecting means 103, a predicting means 104, a switching means 105, a base station position acquiring means 106, and a host vehicle position acquiring means 107 is illustrated.

The first communication means 101 is connected to a first wireless communication network via the first antenna ANT1 and performs communication.

The second communication means 102 is connected to a second wireless communication network different from the first wireless communication network via the second antenna ANT2 and performs communication.

The detecting means 103 detects a blocking object that affects communication between the vehicle V1 and the base station from image data or the like captured by the camera 110. The base station to which the vehicle V1 is connected may change according to the movement of the vehicle. In the present example embodiment, the detecting means 103 detects a blocking object equal to or larger than a predetermined size and appearing in the image data.

The base station position acquiring means 106 acquires, from the first communication means 101, the information of the base station being connected, and specifies the position of the base station. As a method of specifying the position of the base station, a method of specifying the position from the inside-range cell information, the radio field intensity, or the like obtained from the first communication means 101 can be adopted. In addition, as the method of specifying the position of the base station, a method of inquiring the position of the base station with a base station ID or the like as a key to a server or the like on an external network, and receiving the position of the base station can be considered.

The host vehicle position acquiring means 107 is a means for acquiring the position information of the vehicle V1, and includes, for example, a global positioning system (GPS) or the like.

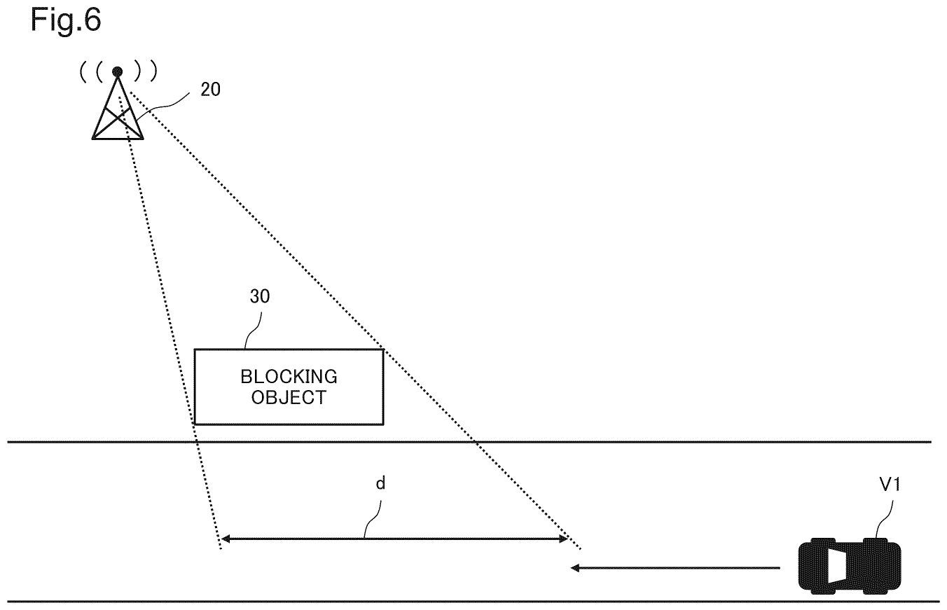

The predicting means 104 predicts a change in communication quality of the first wireless network used by the moving body for communication with the outside, based on the detected position and size of the blocking object. Specifically, as illustrated in FIG. 6, the predicting means 104 predicts a change in the communication quality of the first wireless network from the positions and sizes of the vehicle V1, the base station 20, and the blocking object. For example, as illustrated in FIG. 6, the predicting means 104 calculates a section d in a forward direction where communication with the base station 20 is affected by the blocking object due to the influence of the blocking object 30, and predicts that the communication quality of the first wireless network deteriorates while passing through the section d. Of course, a period during which the communication quality of the first wireless network continues to deteriorate may vary depending on the speed of the vehicle V1, the size of the blocking object, and the like. In addition, the degree of deterioration of the communication quality of the first wireless network can vary depending on the size of the blocking object and a distance between the vehicle V1, the blocking object 30, and the base station 20.

The switching means 105 switches the wireless network being connected, based on the predicted period during which the communication quality of the first wireless network deteriorates. Specifically, the switching means 105 performs an operation of switching the first wireless network to the second wireless network in a case where the degree of deterioration in the communication quality of the first wireless network is larger than a predetermined threshold and the deterioration period is longer than a predetermined threshold. The period for switching to the second wireless network may be a predetermined fixed period, or may be decided based on the period during which the communication quality of the first wireless network predicted by the predicting means 104 deteriorates.

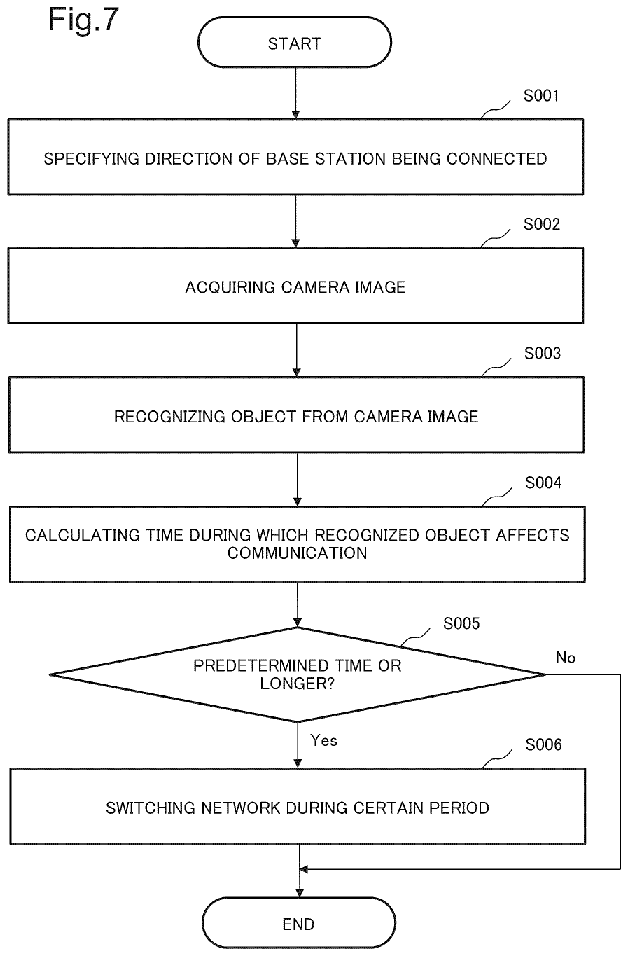

Next, the operation of the present example embodiment will be described in detail with reference to the drawings. FIG. 7 is a flowchart illustrating an operation of the in-vehicle terminal 100 according to the first example embodiment of the present invention. Referring to FIG. 7, first, the in-vehicle terminal 100 acquires the information of the base station being connected and specifies the position of the base station (step S001).

Next, the in-vehicle terminal 100 acquires image data from the camera 110 (step S002). Further, the in-vehicle terminal 100 recognizes an object (blocking object) from the acquired image data, and grasps the positional relationship among the host vehicle, the base station 20, and the blocking object 30 (step S003).

Next, the in-vehicle terminal 100 calculates a period during which the recognized object (blocking object) affects communication, that is, a period during which the communication quality of the first wireless network deteriorates (step S004). Note that in a case where there is a plurality of objects (blocking objects), the in-vehicle terminal 100 calculates a period during which the communication quality of the first wireless network deteriorates by a predetermined value or more.

Next, the in-vehicle terminal 100 determines whether the calculated period during which the communication quality of the first wireless network deteriorates is equal to or more than a predetermined threshold (step S005). As a result of the determination, if the period during which the communication quality of the first wireless network deteriorates is less than the predetermined threshold (No in step S005), the in-vehicle terminal 100 does not switch the wireless network.

On the other hand, as a result of the determination, if the period during which the communication quality of the first wireless network deteriorates is equal to or more than the predetermined threshold (Yes in step S005), the in-vehicle terminal 100 switches the wireless network (step S006). Specifically, the in-vehicle terminal 100 performs an operation of switching the wireless network being connected from the first wireless network to the second wireless network.

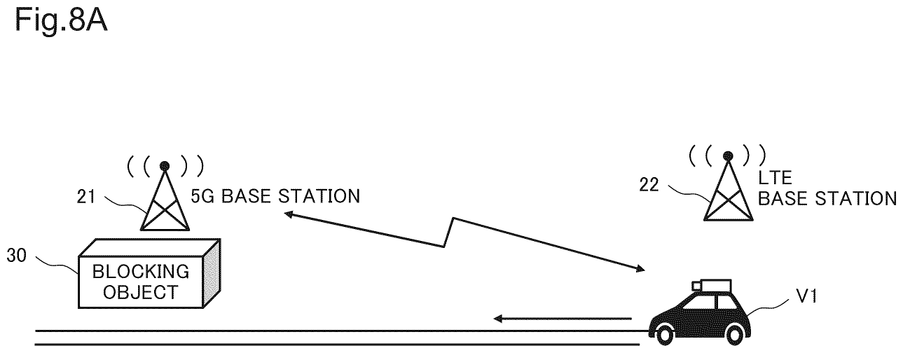

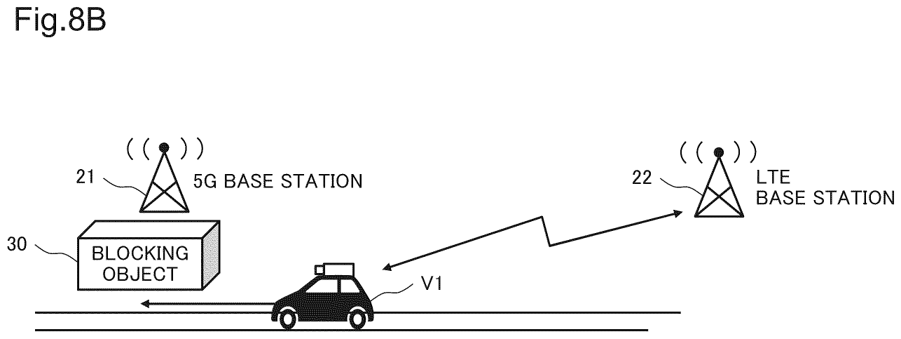

FIGS. 8A and 8B are diagrams for explaining the operation of the in-vehicle terminal 100 according to the first example embodiment of the present invention. FIG. 8A illustrates a state where the in-vehicle terminal 100 mounted on the vehicle V1 is connected to the first wireless network via a 5G base station 21. From this state, the in-vehicle terminal 100 predicts, based on the image data, that the communication between the first antenna ANT1 of the host device and the 5G base station 21 becomes the over-the-horizon communication due to the blocking object 30 in the future, and the communication quality of the first wireless network deteriorates for a predetermined period. Then, before the communication quality of the first wireless network deteriorates due to the presence of the blocking object 30, the in-vehicle terminal 100 switches the wireless network by connecting to the second wireless network via the LTE base station 22 as illustrated in FIG. 8B. Accordingly, it is possible to avoid deterioration, interruption, or the like of the communication quality of the first wireless network. As illustrated in the cases of 5G and LTE in FIGS. 8A and 8B, the frequency band used in the second wireless network is preferably a frequency band that is less susceptible to the blocking object than the frequency band used in the first wireless network. In addition, the communication scheme used in the second wireless network is preferably a communication scheme that does not require more straightness than the communication scheme used in the first wireless network. In this way, even in a situation where the deterioration of the communication quality of the first wireless network is expected, it is possible to increase the possibility that the communication quality can be secured in the second wireless network.

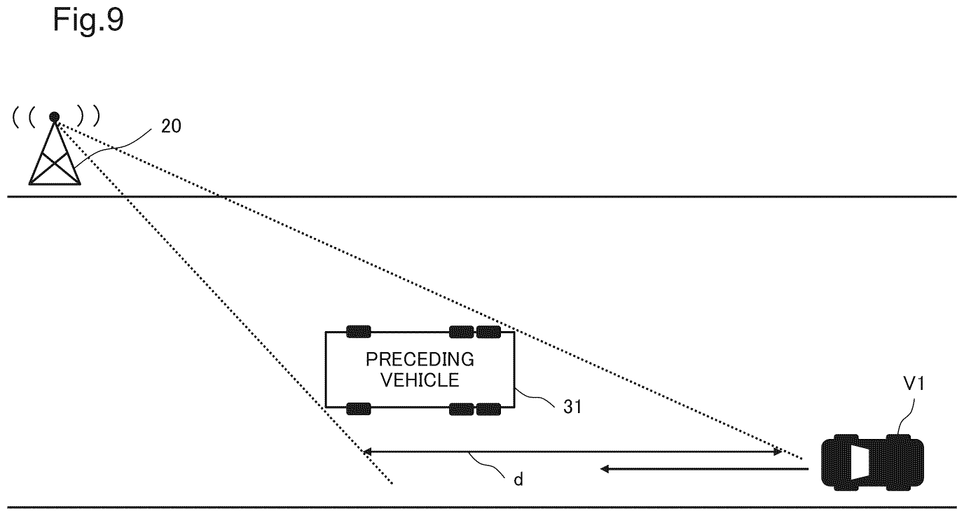

In the above-described example embodiments, it has been described that the blocking object 30 does not move, but a vehicle traveling around the vehicle V1 may become the blocking object 30. For example, as illustrated in FIG. 9, a vehicle 31 traveling in a lane adjacent to the vehicle V1 becomes a blocking object. The section d in which the communication with the base station 20 in this case is affected by the blocking object can be calculated from a relative speed between the vehicle V1 and the vehicle 31. In particular, the relative speed between the vehicle V1 and the vehicle 31 may be close to 0, in other words, the vehicle V1 and the vehicle 31 may travel in parallel while maintaining the positional relationship in FIG. 9. The present invention is effective in such a case, and when the in-vehicle terminal 100 of the vehicle V1 switches to the second wireless network at an early stage, it is possible to avoid a situation in which the communication quality deteriorates or the communication is disconnected due to the presence of the vehicle 31. Of course, in a case where there is a base station behind the host vehicle, the vehicle 31 behind the host vehicle may be a blocking object. Also in this case, the in-vehicle terminal 100 predicts a change in the communication quality of the first wireless network based on the position and size of the blocking object, and switches the wireless network as necessary.

In the above description, the predicting means 104 predicts the change in the communication quality of the first wireless network, but on a similar principle, the predicting means 104 may predict the communication quality of the second wireless network from the blocking object or the like and transmit the predicted communication quality to the switching means 105. Then, the switching means 105 compares the predicted degrees and periods of deterioration in the communication quality of the first and second wireless networks, and decides whether to switch the wireless network being connected. In this way, it is possible to avoid a phenomenon in which the connection to the first or second wireless network is frequently switched.

### Second Example Embodiment

In the first example embodiment described above, it has been described that the in-vehicle terminal 100 recognizes the blocking object in the direction of the base station based on the image data and predicts the change in the communication quality of the first wireless network. However, in a case where a vehicle enters a tunnel or an underpass (hereinafter, referred to as a “tunnel or the like”), it may be difficult to predict the communication quality of the first wireless network. Next, a second example embodiment in which a tunnel or the like is detected based on image data obtained by imaging a traveling direction of the moving body will be described in detail with reference to the drawings.

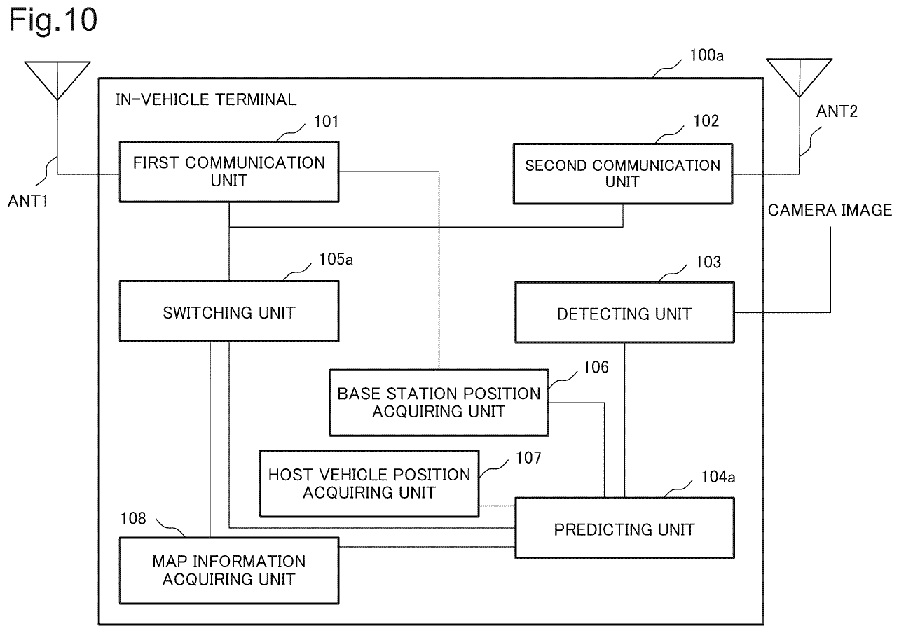

FIG. 10 is a functional block diagram illustrating a configuration of an in-vehicle terminal according to a second example embodiment of the present invention. A difference from the first example embodiment illustrated in FIG. 5 is that a map information acquiring means 108 is added to an in-vehicle terminal 100a, and operations of a predicting means 104a and a switching means 105a are different. Since the other configurations are similar to those of the first example embodiment, the difference will be mainly described below.

The map information acquiring means 108 acquires map information including a tunnel on a road through which the vehicle V1 passes and base station information. Map information held by the in-vehicle terminal 100a for car navigation or the like may be used as the map information. The map information may be map information acquired by the map information acquiring means 108 from a map server or the like on a cloud base by using the first communication means 101 or the second communication means 102.

The predicting means 104a predicts the change in the communication quality of the first wireless network with reference to the position information of the vehicle V1 and the map information separately from the blocking object detected by the detecting means 103. Specifically, the predicting means 104a refers to the map information, and in a case where there is a tunnel or the like in the forward direction of the vehicle V1, predicts the change in the communication quality of the first wireless network based on the length of the tunnel or the like.

The switching means 105a refers to the map information in addition to the period during which the communication quality of the first wireless network deteriorates due to the tunnel or the like, and switches the wireless network being connected, based on the presence or absence of the base station in the tunnel.

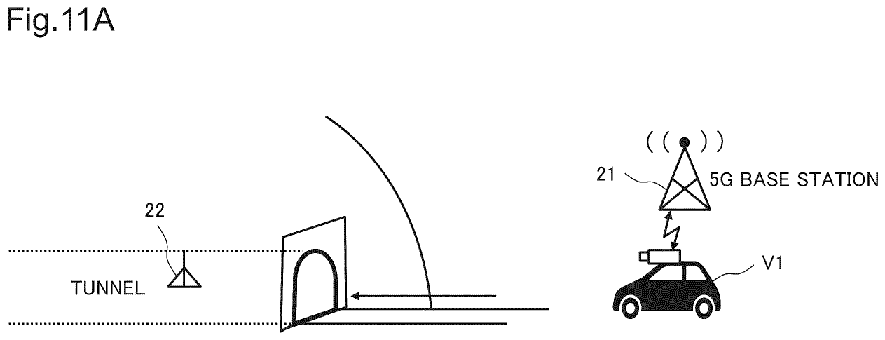

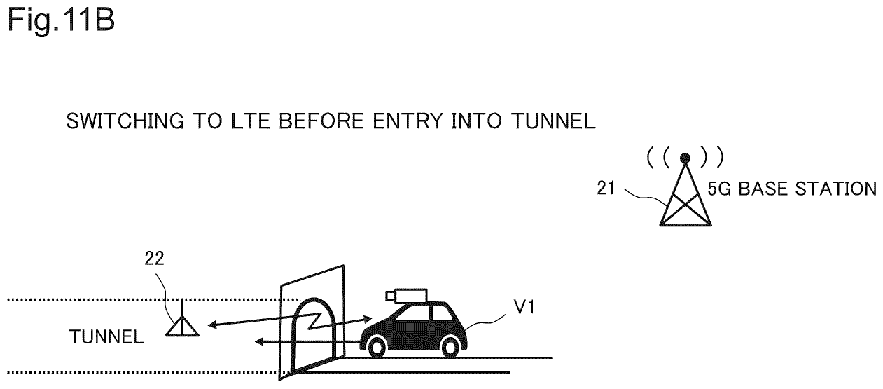

FIGS. 11A and 11B are diagrams for explaining the operation of the in-vehicle terminal 100a according to the second example embodiment of the present invention. FIG. 11A illustrates a state where the in-vehicle terminal 100a mounted on the vehicle V1 is connected to the first wireless network via the 5G base station 21. From this state, the in-vehicle terminal 100a predicts that the communication quality of the first wireless network deteriorates when the vehicle V1 enters the tunnel. Then, before the communication quality of the first wireless network deteriorates due to the entry into the tunnel, the in-vehicle terminal 100a connects to the LTE base station 22 in the tunnel and switches the wireless network as illustrated in FIG. 11B. Accordingly, it is possible to avoid deterioration, interruption, or the like of the communication quality of the first wireless network.

In the above description, it has been described that the in-vehicle terminal 100a detects a tunnel or the like based on the position information of the vehicle and the map information, but the tunnel or the like may be detected from the image data obtained by the camera 110. Based on a combination of the position information of the vehicle and the map information, and the image data captured by the camera, the in-vehicle terminal 100a may detect a tunnel or the like and predict the deterioration of communication quality. For example, entry into a tunnel may be detected based on the image data, and a period during which the communication quality deteriorates may be predicted based on the position information and the map information.

Although the example embodiments of the present invention have been described above, the present invention is not limited to the above-described example embodiments, and further modifications, substitutions, and adjustments can be made without departing from the basic technical idea of the present invention. For example, the configuration of the system, the configuration of each element, and the expression form of data and the like illustrated in the drawings are examples for assisting the understanding of the present invention, and are not limited to the configurations illustrated in the drawings. For example, in the first and second example embodiments described above, it has been described that the moving body is a vehicle (automobile), but the present invention can also be applied to another moving body. For example, the present invention can also be applied to a railway vehicle having a communication function, an unmanned aerial vehicle (UAV), an automatic guided vehicle, and the like. In addition, in the case of the UAV, a combination of 2.4 GHz (or 5.7 GHZ) as the first frequency band and 169 MHz as the second frequency band can be preferably used.

In the above-described example embodiments, it has been described that the in-vehicle terminal 100a predicts the deterioration of the communication quality based on the position and size of the blocking object, but the deterioration of the communication quality of the first wireless network may be predicted by using other information obtained from the image data. For example, the in-vehicle terminal 100a may predict the deterioration of the communication quality by further using at least one of the shape and the material of the blocking object in addition to the position and the size of the blocking object.

In the above-described example embodiments, an example has been described in which the in-vehicle terminal 100a switches the wireless network during the period during which the communication quality deteriorates or during the fixed period, but the switching aspect of the wireless network is not limited thereto. For example, it is also possible to adopt an aspect in which the in-vehicle terminal 100a acquires image data at any time and returns the second wireless network to the first wireless network in a case where the blocking object is no longer detected.

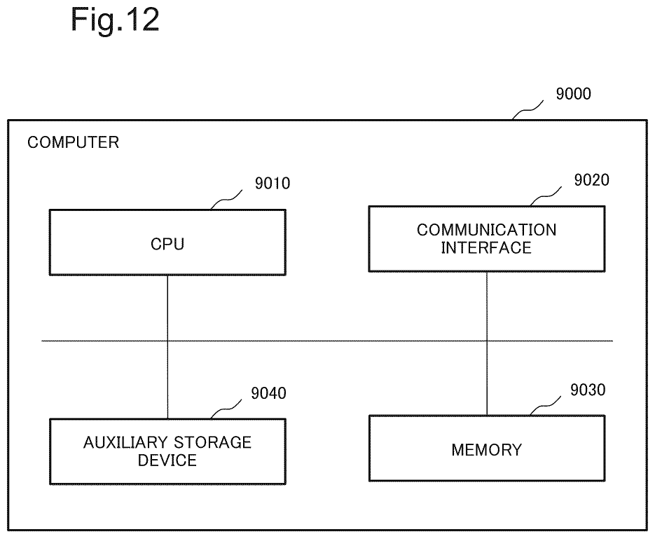

The procedure described in each of the above-described example embodiments can be achieved by a computer that functions as a device constituting the communication control device 10 and the in-vehicle terminals 100 and 100a. Specifically, the present invention can be achieved by a program for causing a computer (9000 in FIG. 12) to achieve functions as these devices. Such a computer is exemplified by a configuration including a central processing unit (CPU) 9010, a communication interface 9020, a memory 9030, and an auxiliary storage device 9040 in FIG. 12. That is, a communication quality prediction program and a network switching program may be executed by the CPU 9010 in FIG. 12. In addition, this program can be recorded on a computer-readable (non-transitory) recording medium.

That is, each unit (processing means and function) of the communication control device 10 and the in-vehicle terminals 100 and 100a described above can be achieved by a computer program that causes a processor mounted on these devices to execute each processing described above by using the hardware thereof.

The disclosure of the above patent literature is incorporated herein by reference. Within the frame of the entire disclosure (including the claims) of the present invention, it is possible to change and adjust the example embodiments or examples further based on the basic technical idea thereof. In addition, various combinations or selections (including partial deletions) of various disclosure elements (including each element of each claim, each element of each example embodiment or example, each element of each drawing, and the like) can be made within the frame of the disclosure of the present invention. That is, it is a matter of course that the present invention includes various modifications and corrections that can be made by those skilled in the art in accordance with the entire disclosure including the claims and the technical idea. In particular, for numerical ranges set forth herein, any numerical value or sub-range included within the range should be construed as being specifically described, even if not stated otherwise.

### REFERENCE SIGNS LIST

10 communication control device
11 detecting means
12 predicting means
20 base station
21 5G base station
22 LTE base station
30 blocking object
31 vehicle
100, 100a in-vehicle terminal
101 first communication means
102 second communication means
103 detecting means
104, 104a predicting means
105, 105a switching means
106 base station position acquiring means
107 host vehicle position acquiring means
108 map information acquiring means
110 camera
9000 computer
9010 CPU
9020 communication interface
9030 memory
9040 auxiliary storage device
ANT1 first antenna
ANT2 second antenna
V1 vehicle

What is claimed is:

1. A communication control device that is mounted in a moving body, the communication control device comprising:
a memory; and
at least one processor coupled to the memory
the at least one processor performing operations to:
detect, based on image data obtained by imaging a direction of a base station to which the moving body is connected, a blocking object between the moving body and the base station to which the moving body is connected; and
predict, based on a position and a size of the detected blocking object, a change in communication quality of a first wireless network used by the moving body for external communication.

2. The communication control device according to claim 1, wherein the at least one processor further performs operation to:
switch, based on the communication quality of the first wireless network, to communication using a second wireless network different from the first wireless network.

3. The communication control device according to claim 2, wherein the at least one processor further performs operation to:
switch to the communication using the second wireless network in a case where deterioration in the communication quality of the first wireless network continues for a predetermined period.

4. The communication control device according to claim 2, wherein a frequency band used in the first wireless network is a frequency band more susceptible to an influence of a blocking object than a frequency band used in the second wireless network.

5. The communication control device according to claim 1, wherein the at least one processor further performs operation to:
predict, based on a relative speed between the moving body and the blocking object, a period during which deterioration in the communication quality of the first wireless network continues.

6. The communication control device according to claim 1, wherein the at least one processor further performs operation to:
detect, as the blocking object, another moving body travelling around the moving body.

7. The communication control device according to claim 1, wherein the at least one processor further performs operation to:
predict, by referring to map information, the change in the communication quality of the first wireless network.

8. A communication control method comprising:
detecting, based on image data obtained by imaging a direction of a base station to which a moving body is connected, a blocking object between the moving body and the base station to which the moving body is connected; and
predicting, based on a position and a size of the detected blocking object, a change in communication quality of a first wireless network used by the moving body for external communication.

9. A non-transitory computer-readable recording medium storing a program for causing a computer constituting a communication control device mounted on a moving body to execute:
detecting, based on image data obtained by imaging a direction of a base station to which the moving body is connected, a blocking object between the moving body and the base station to which the moving body is connected; and
predicting, based on a position and a size of the detected blocking object, a change in communication quality of a first wireless network used by the moving body for external communication.
